(19) United States
(12) Patent Application Publication
(10) Pub. No.: US 2022/0022289 A1
(43) Pub. Date: Jan. 20, 2022

(54) METHOD AND ELECTRONIC DEVICE FOR PROVIDING AUDIO RECIPE AND COOKING CONFIGURATION

(71) Applicant: Samsung Electronics Co., Ltd., Suwon-si, Gyeonggi-do (KR)

(72) Inventors: Amitoj SINGH, Noida (IN); Kyuhee LEE, Suwon-si (KR); Ridhi CHUGH, Noida (IN); Hyerim LEE, Suwon-si (KR); Shazia JAMAL, Noida (IN); Amit SAXENA, Noida (IN); Arvind Krishna SUSHIL, Noida (IN); Bokul BORAH, Noida (IN); Kumar SHUBHAM, Noida (IN); Mahelaqua M, Noida (IN); Vikas CHOPRA, Noida (IN); Murtuza Saifuddin VHORA, Noida (IN); Paridhi TOSHNIWAL, Noida (IN); Ranjesh VERMA, Noida (IN); Sabyasachi KUNDU, Noida (IN); Srinivasa Rao CHANDAKA, Noida (IN); Susovan Vivekananda MAJUMDER, Noida (IN); Tasleem ARIF, Noida (IN)

(21) Appl. No.: 17/289,539

(22) PCT Filed: Oct. 31, 2019
(86) PCT No.: PCT/KR2019/014533

§ 371 Date: Apr. 28, 2021

(30) Foreign Application Priority Data
Oct. 31, 2018 (IN) 201841041101

(51) Int. Cl. H05B 6/64; G06F 40/284

(52) U.S. Cl. CPC H05B 6/6441; G09B 19/0092; G06F 40/284

(57) ABSTRACT

Accordingly, embodiments herein disclose a method for providing an audio recipe and a cooking configuration. The method includes receiving cooking instructions from at least one data source. Further, the method includes obtaining at least one recipe parameter from the cooking instructions. Further, the method includes dynamically generating the audio recipe and the cooking configuration corresponding to the audio recipe based on the at least one recipe parameter. Further, the method includes storing the audio recipe and the cooking configuration.

### CROSS-REFERENCE TO RELATED APPLICATION(S)

This application is a U.S. National Stage application under 35 U.S.C. § 371 of an International application number PCT/KR2019/014533, filed on Oct. 31, 2019, which is based on and claims priority of an Indian patent application number 201841041101, filed on Oct. 31, 2018, in the Indian Patent Office, the disclosure of which is incorporated by reference herein in its entirety.

### TECHNICAL FIELD

The present disclosure relates to a cooking system, and more specifically related to a method and electronic device for providing an audio recipe and a cooking configuration.

### BACKGROUND ART

People tend to have difficulty using a microwave oven because of the following reasons:

People learn new recipes through a number of sources (e.g., phone calls, printed recipes, text messages, or the like). However, it is difficult to memorize and apply same microwave settings when preparing same recipe next time, and

There are limited number of pre-built recipes in the microwave oven. This leaves out a huge number of regional dishes.

Thus, it is desired to address the above-mentioned disadvantages or other shortcomings or at least provide a useful alternative.

### DISCLOSURE OF INVENTION

### Solution to Problem

In accordance with an aspect of the present disclosure, embodiments herein disclose a method for providing an audio recipe and a cooking configuration. The method includes receiving cooking instructions from at least one data source. Further, the method includes obtaining at least one recipe parameter from the cooking instructions. Further, the method includes dynamically generating the audio recipe and the cooking configuration corresponding to the audio recipe based on the at least one recipe parameter. Further, the method includes storing the audio recipe and the cooking configuration.

In an embodiment, the method includes activating a dynamic recipe mode. Further, the method includes automatically providing at least one cooking instruction by executing the audio recipe in the dynamic recipe mode. Further, the method includes automatically setting a cooking appliance by applying the cooking configuration corresponding to the audio recipe.

In an embodiment, providing the at least one cooking instruction includes providing an ingredient preparation instruction and providing an instruction on loading a set of ingredients in the cooking appliance.

In an embodiment, at least one data source includes a call, a microphone at a cooking appliance, a chat history, an image document, a video content, and a virtual assistant application. The at least one data source is obtained from at least one of an offline mode and an online mode.

In an embodiment, the at least one data source is operating in a recipe mode.

In an embodiment, obtaining the at least one recipe parameter from the cooking instructions includes identifying at least one keyword from the cooking instructions, determining whether the at least one keyword match with at least one of time, temperature, a mode of the cooking appliance and the ingredient in a cooking database, and extracting the at least one recipe parameter from the cooking instructions based on the at least one identified keyword when the match is detected.

In an embodiment, obtaining the at least one recipe parameter from the cooking instructions includes identifying at least one keyword from the cooking instructions, determining whether the at least one keyword match with at least one of time, temperature, a mode of the cooking appliance and the ingredient in a cooking database, automatically downloading an ingredients database, matching the at least one keyword with information available in the ingredients database and extracting the at least one recipe parameter from the cooking instructions based on the at least one identified keyword.

In accordance with another aspect of the present disclosure, embodiments herein disclose a cooking appliance for providing an audio recipe and a cooking configuration. The cooking appliance includes a cooking controller coupled to a memory and a processor. The cooking controller is configured to receive the cooking instructions from at least one data source and obtain at least one recipe parameter from the cooking instructions. Further, the cooking controller is configured to generate the audio recipe and the cooking configuration corresponding to the audio recipe based on the at least one recipe parameter and store the audio recipe and the cooking configuration.

In accordance with another aspect of the present disclosure, embodiments herein disclose an electronic device for providing an audio recipe and a cooking configuration. The electronic device includes a cooking controller coupled to a memory and a processor. The cooking controller is configured to receive cooking instructions from at least one data source and obtain at least one recipe parameter from the cooking instructions. The cooking controller is configured to generate the audio recipe and the cooking configuration corresponding to the audio recipe for a cooking appliance based on the at least one recipe parameter. The cooking controller is configured to store the audio recipe and the cooking configuration and share the audio recipe and the cooking configuration with the cooking appliance.

In accordance with another aspect of the present disclosure, embodiments herein disclose a system for providing an audio recipe and a cooking configuration. The system includes an electronic device and a cooking appliance. The electronic device is configured to receive cooking instructions from at least one data source and obtain at least one recipe parameter from the cooking instructions. Further, the electronic device is configured to dynamically generate the audio recipe and the cooking configuration corresponding to the audio recipe based on the at least one recipe parameter and store the audio recipe and the cooking configuration. Further, the electronic device is configured to share the audio recipe and the cooking configuration with the cooking appliance. The cooking appliance is configured to activate a dynamic recipe mode and automatically provide at least one cooking instruction by executing the audio recipe in the dynamic recipe mode. The system automatically sets the cooking appliance by applying the cooking configuration for the recipe.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

This method is illustrated in the accompanying drawings, throughout which like reference letters indicate corresponding parts in the various figures. The embodiments herein will be better understood from the following description with reference to the drawings, in which:

FIG. 1 is a block diagram of a cooking appliance for providing an audio recipe and a cooking configuration, according to an embodiment as disclosed herein;

FIG. 2 is a block diagram of an electronic device for providing the audio recipe and the cooking configuration, according to an embodiment as disclosed herein;

FIG. 3 is a block diagram of a cooking controller, according to an embodiment as disclosed herein;

FIG. 4 is an overview of a system for providing the audio recipe and the cooking configuration, according to an embodiment as disclosed herein;

FIG. 5 is an example block diagram of the cooking appliance, according to an embodiment as disclosed herein;

FIG. 6 is a flow diagram illustrating various operations implemented, by the cooking appliance, for generating the audio recipe and the cooking configuration, according to an embodiment as disclosed herein;

FIG. 7 is a flow diagram illustrating various operations implemented, by the electronic device, for providing the audio recipe and the cooking configuration, according to an embodiment as disclosed herein;

FIGS. 8A and 8B are flow diagrams illustrating various operations implemented, by the cooking appliance, for generating the audio recipe and the cooking configuration, according to an embodiment as disclosed herein;

FIG. 9 is a flow diagram illustrating various operations implemented, by the cooking appliance, for applying the audio recipe and the cooking configuration, according to an embodiment as disclosed herein;

FIGS. 10, 11, and 12 are example scenarios in which the cooking appliance extracts recipe parameters from the cooking instructions over a data source in a recipe mode, according to an embodiment as disclosed herein;

FIGS. 13 and 14 are example scenarios in which the cooking appliance extracts the recipe parameters from the cooking instructions, according to an embodiment as disclosed herein;

FIG. 15 is an example scenario in which the cooking appliance applies the audio recipe and the cooking configuration, according to an embodiment as disclosed herein; and

FIGS. 16A, 16B, and 16C are example scenarios in which the application of cooking configuration in the cooking appliance is depicted, according to an embodiment as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

The terms, the cooking appliance, the smart oven, and the microwave oven are used interchangeably in the disclosure.

Accordingly, embodiments herein achieve a method for generating an audio recipe and a cooking configuration. The method includes receiving cooking instructions from at least one data source. Further, the method includes extracting recipe parameters from the cooking instructions. Further, the method includes dynamically generating the audio recipe and the cooking configuration for a recipe based on the recipe parameters. Further, the method includes storing the audio recipe and the cooking configuration.

Unlike conventional methods and systems, the method can be used to generate on-the fly audio recipe and the cooking configuration for a cooking appliance in an effective manner Based on the proposed methods, the cooking appliance can be used to extract oven-related information when a recipe is presented to any of its connected devices (e.g., smart phone or the like), save the information in a ready-to-use format, and then automatically apply these settings from the next time the same recipe needs to be prepared. This results in improving comport level to the user. The method can be used to reduce preparation time and provide more nutrition by using required fewer ingredients.

In an example, if a woman is conversing in telephone with her mother about a recipe, the microwave oven extracts related information from the conversation. It parses the information and save it in a ready-to-use format. It finally presents this recipe as a new recipe mode in the smart oven. From next time, the woman can simply select this recipe in the smart oven, and the related settings will automatically be applied.

Based on the proposed method, the recipes are dynamically added and the user can interactively add self-curated recipes via various input mediums, like parsing from telephonic conversation, scanning from recipe book, etc. the cooking parameters are directly generated from input recipe sources, and can be applied on the cooking appliance at runtime.

Based on the proposed methods, the smart oven is capable of maintaining different versions of the settings of the newly learnt recipe. The different versions vary in the time required for the preparation of the recipe. Correspondingly, the nutritional value of the prepared food will also vary. The user of the cooking appliance can then choose the version that the user wants to prepare, making a trade-off between time required for preparation and the nutritional value.

In the proposed methods, the recipes are dynamically added and created on-the-fly from the data source (e.g., voice call, video or the like). The method can be used to record the entire recipe and then further assist the user by automatically applying the settings as well when the recipe is next prepared.

The user of the cooking appliance will not need to memorize the recipe or the settings for it. More number of relevant recipes will be available to the user. User will be able to add as many recipes to the list as the user wants. Even for recipes that exist in microwave already, the user will be able to save regional variant of it to suit his/her culinary preferences. The user will still be able to prepare the recipe if the user of the appliance is short on time, using one of the variations of the recipe that the microwave automatically generates. The user can always be sure that the user is consuming the right amount of nutrients by seeing the nutrient content of the recipe that he is about to prepare.

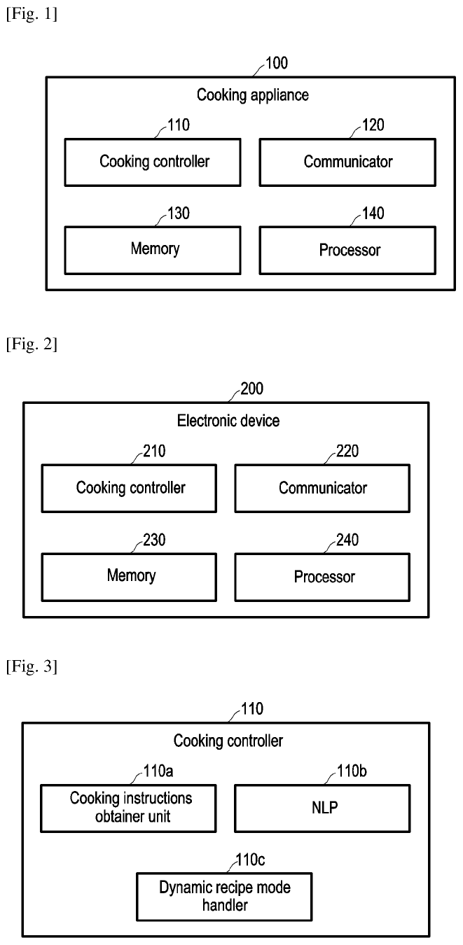

Referring now to the drawings, and more particularly to FIGS. 1 through 16C, there are shown preferred embodiments.

FIG. 1 is a block diagram of a cooking appliance 100 for providing an audio recipe and a cooking configuration, according to an embodiment as disclosed herein. The cooking appliance 100 can represent a variety of electronic devices utilized to cook food items, including, but not limited to, a microwave oven, a toaster oven, a conventional oven, a barbecue grill, or the like. In an embodiment, the cooking appliance 100 includes a cooking controller 110, a communicator 120, a memory 130 and a processor 140.

The cooking controller 110 is configured to receive cooking instructions from at least one data source and extract recipe parameters from the cooking instructions. In an example, the data source can be, for example but not limited to a call, a microphone at the cooking appliance 100, a chat history, an image document, a video content, and a virtual assistant application. In an embodiment, the data source is operating in a recipe mode. The data source is obtained over an offline mode and an online mode.

In an embodiment, the cooking controller 110 is configured to identify keywords from the cooking instructions and determine whether the keywords match with at least one of time, temperature, a mode of the cooking appliance 100 and the ingredient in a cooking database. Further, the cooking controller 110 is configured to extract the recipe parameters from the cooking instructions based on the at least one identified keyword when the match is detected.

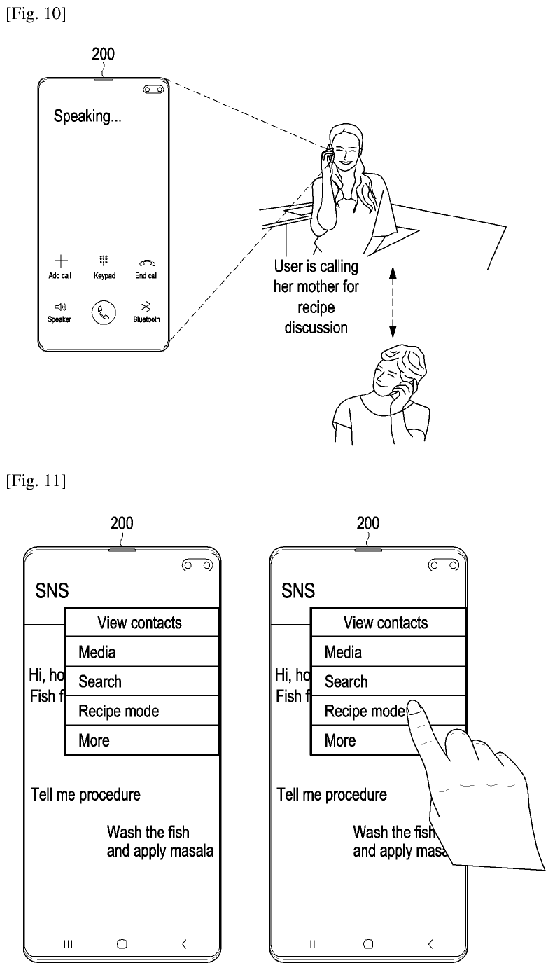

In another embodiment, the cooking controller 110 is configured to identify keywords from the cooking instructions and determine whether the keywords match with at least one of time, temperature, the mode of the cooking appliance 100 and the ingredient in the cooking database. Further, the cooking controller 110 is configured to automatically download an ingredients database, and match the keywords with information available in the ingredients database. Further, the cooking controller 110 is configured to extract the recipe parameters from the cooking instructions based on the at least one identified keyword. The recipe parameters extracted from the cooking instructions are explained detail in the FIGS. 8A and 8B.

Further, the cooking controller 110 is configured to dynamically generate the audio recipe and the cooking configuration for the recipe based on the recipe parameters and store the audio recipe and the cooking configuration in the memory 130.

In an embodiment, the cooking controller 110 is configured to activate a dynamic recipe mode and automatically provide at least one cooking instruction by executing the audio recipe in the dynamic recipe mode. Further, the cooking controller 110 automatically configures the cooking appliance 100 by applying the cooking configuration for the recipe. In an embodiment, automatically providing the at least one cooking instruction includes providing an ingredient preparation instruction and providing an instruction on loading a set of ingredients in the cooking appliance 100.

The processor 140 is operated with the cooking controller 110, the communicator 120, and the memory 130. The processor 140 is configured to execute instructions stored in the memory 130 and to perform various processes. The communicator 120 is configured for communicating internally between internal hardware components and with external devices via one or more networks. The communicator 120 is configured for communicating with the cooking controller 110 in the cooking appliance 100.

The memory 130 also stores instructions to be executed by the processor 140. The memory 130 includes a cooking database and ingredients database. The memory 130 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 130 may, in some examples, be considered a non-transitory storage medium. The term “non-transitory” may indicate that the storage medium is not embodied in a carrier wave or a propagated signal. However, the term “non-transitory” should not be interpreted that the memory 130 is non-movable. In some examples, the memory 130 can be configured to store larger amounts of information than the memory. In certain examples, a non-transitory storage medium may store data that can, over time, change (e.g., in Random Access Memory (RAM) or cache).

Although the FIG. 1 shows various hardware components of the cooking appliance 100 but it is to be understood that other embodiments are not limited thereon. In other embodiments, the cooking appliance 100 may include less or more number of components. Further, the labels or names of the components are used only for illustrative purpose and does not limit the scope of the invention. One or more components can be combined together to perform same or substantially similar function to provide the audio recipe and the cooking configuration in the cooking appliance 100.

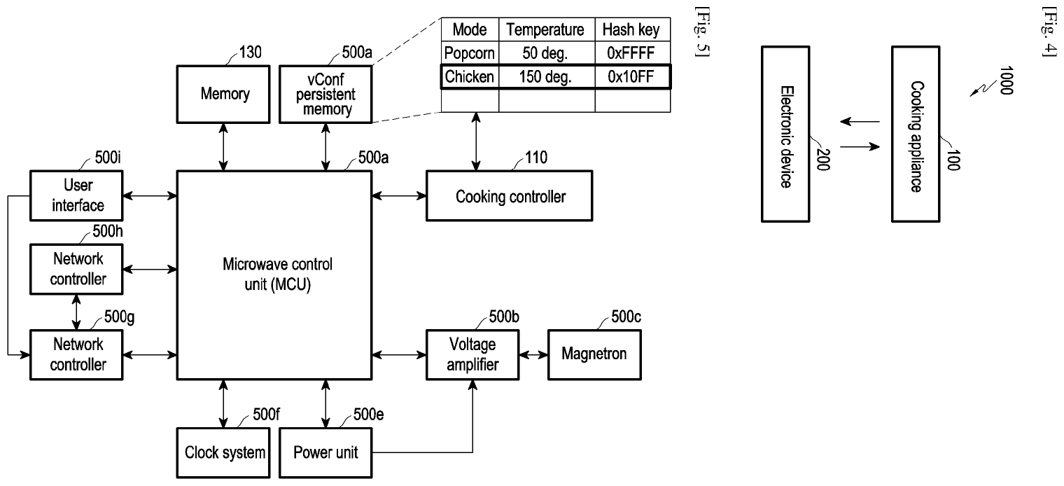

FIG. 2 is a block diagram of an electronic device 200 for providing the audio recipe and the cooking configuration, according to an embodiment as disclosed herein. The electronic device 200 can be, for example, but not limited to a cellular phone, a smart phone, a Personal Digital Assistant (PDA), a tablet computer, a laptop computer, or the like.

In an embodiment, the electronic device 200 includes a cooking controller 210, a communicator 220, a memory 230 and a processor 240. The cooking controller 210 is configured to receive the cooking instructions from the at least one data source and extract the recipe parameters from the cooking instructions. The cooking controller 210 is configured to dynamically generate the audio recipe and the cooking configuration for the recipe based on the recipe parameters. The cooking controller 210 is configured to store the audio recipe and the cooking configuration in the memory 230 and share the audio recipe and the cooking configuration for the recipe with the cooking appliance 100.

In an embodiment, the cooking controller 210 includes a cooking instructions obtainer unit, a natural language processor and a dynamic recipe mode handler used to prepare and share the audio recipe and the cooking configuration for the recipe with the cooking appliance 100.

The communicator 220 is configured for communicating internally between internal hardware components and with external devices via one or more networks. The processor 240 is configured to execute instructions stored in the memory 230 and to perform various processes.

The memory 230 also stores instructions to be executed by the processor 240. The memory 230 includes a cooking database and ingredients database. The memory 230 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 230 may, in some examples, be considered a non-transitory storage medium. The term “non-transitory” may indicate that the storage medium is not embodied in a carrier wave or a propagated signal. However, the term “non-transitory” should not be interpreted that the memory 230 is non-movable. In some examples, the memory 230 can be configured to store larger amounts of information than the memory. In certain examples, a non-transitory storage medium may store data that can, over time, change (e.g., in Random Access Memory (RAM) or cache).

Although the FIG. 2 shows various hardware components of the electronic device 200 but it is to be understood that other embodiments are not limited thereon. In other embodiments, the electronic device 200 may include less or more number of components. Further, the labels or names of the components are used only for illustrative purpose and does not limit the scope of the invention. One or more components can be combined together to perform same or substantially similar function to generate the audio recipe and the cooking configuration in the electronic device 200.

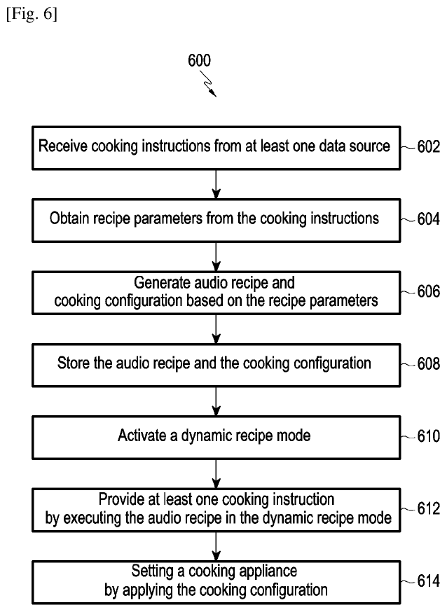

FIG. 3 is a block diagram of the cooking controller 110, according to an embodiment as disclosed herein. In an embodiment, the cooking controller 110 includes a cooking instructions obtainer unit 110a, a natural language processor (NLP) 110b, and a dynamic recipe mode handler 110c.

The cooking instructions obtainer unit 110a is configured to receive the cooking instructions from the data source and extract recipe parameters from the cooking instructions.

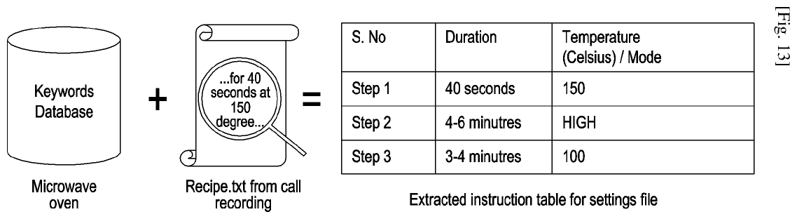

In an example, when the recipe is being discussed over the smart phone, the user can enable a ‘recipe mode’ on the phone. The conversation will be recorded on the smart phone and sent to a smart oven over a communication medium (e.g., Wi-Fi direct, Bluetooth or the like) as shown in the FIG. 10.

In another example, if the discussion is taking place over a text chat on a social networking site (SNS), the user can enable the ‘recipe mode’ on the smart phone. The following conversation will be streamed to the smart oven for processing over the communication medium as shown in the FIG. 11.

In another example, if the user watches a cooking program in the smart phone or a smart TV and enables the ‘recipe mode’ on the smart phone or the smart TV. The following program information will be streamed to the smart oven for processing over the communication medium as shown in the FIG. 12.

In another example, the smart oven may contain built-in microphone, through which it may record an ongoing conversation between the users. In another example, the smart oven may contain an embedded camera, through which the user can capture the image of the recipe written in the paper. In another example, the smart oven will be able to operate in an Internet of things (JOT) environment in synchronize with at least one connected device (e.g., smart phone or the like) and delegate tasks pertaining to the connected device.

In an embodiment, the NLP 110b is configured to identify keywords from the cooking instructions and determine whether the keywords match with at least one of time, temperature, the mode of the cooking appliance 100 and the ingredient in the cooking database. Further, the NLP 110b is configured to extract the recipe parameters from the cooking instructions based on the at least one identified keyword when the match is detected.

In another embodiment, the NLP 110b is configured to identify keywords from the cooking instructions and determine whether the keywords match with at least one of time, temperature, the mode of the cooking appliance 100 and the ingredient in the cooking database. Further, the NLP 110b is configured to automatically download the ingredients database, and match the keywords with information available in the ingredients database. Further, the NLP 110b is configured to extract the recipe parameters from the cooking instructions based on the at least one identified keyword.

In an example, as the input file can be in any format (e.g., audio format, text format, image format or the like), the NLP 110b first need to convert the input file into text. In an example, a Hidden Markov Model (HMM) speech recognizer is used for audio input: For any kind of audio input, the HMM speech recognizer can convert it into text by doing a speech-to-text conversion. For performing the conversion, the HMM speech recognizer works in three procedures (e.g., endpoint detection procedure, feature extraction procedure and classification procedure).

The endpoint detection procedure: Using signal processing analyze the audio and categorize it as voice signal, non-voice signal, or silence.

Feature extraction procedures: The analog speech signal (voice parts) is converted into numeric values. This is achieved by signal processing techniques of framing and windowing, followed by Discrete Fourier Transform (DFT) and Discrete Cosine Transform (DCT).

Classification procedures: The extracted features are fed into a deep learning model which has already been trained using a number of speech inputs. The recognizer performs classification with this test data, and reports if the data matches with any existing word in its database using an HMM recognizer.

Image to text Conversion: In another example, the characters from the image can be read using optical character recognition (OCR). OCR is a technique which takes an image of a character, and finds that image's pixel values. The pixel values are then fed to a classifier which has already been trained with a number of images of different characters. The classifier finds the character which most closely resembles the image provided.

Once the input has been processed, the cooking configuration and the audio recipe can be generated. The cooking configuration and the audio recipe are made by parsing the processed input text file. Sometimes, complete information may not be present in the conversation. In such scenarios, the proposed methods can be used to automatically fill in the missing information.

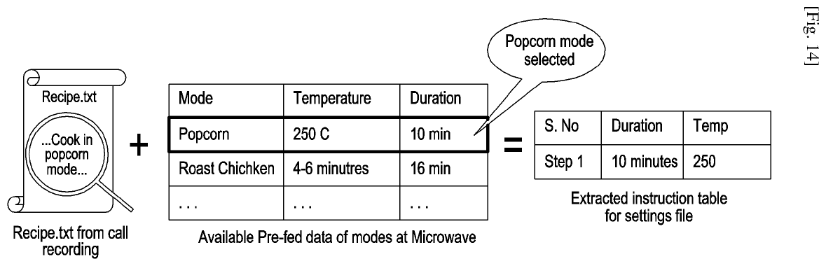

In an example, the cooking appliance 100 contains cooking database/ingredient database of keywords. The keywords contain words like “seconds”, “minutes”, “degrees”, “temperature” etc. For each word in the text, the cooking appliance 100 searches the database to match if the keyword exists. If the keyword does exist, the cooking appliance 100 scans the neighboring words for a numerical value. The numerical value and the keyword provide a complete setting of the cooking appliance 100 as shown in the FIG. 13.

In another example, it may happen that the speaker referred to a particular mode of the smart oven, for e.g., popcorn mode. In such cases, step 1 would not be able to detect any microwave settings, so that the proposed method automatically fills in the cooking configuration from the specified mode. The available modes of the microwave oven are stored in the database. Each mode corresponds to a particular temperature and duration of time. All words in input file are compared against the database. If a mode is found, then corresponding settings are configured as shown in the FIG. 14.

In another example, it may happen that even the mode is not specified in the conversation. In this case, the smart oven tries to auto-fill the cooking configuration by finding out the ingredients involved. In an example, water, for example, corresponds to exactly one mode of operation—boiling at 100 degree Celsius. Milk, on the other hand, can be used in different modes for different recipes—e.g., it can be boiled at 120 degree Celsius for some recipes, or simply heated at 70 degree Celsius for other recipes.

In another example, if the mode which is used most often for a particular ingredient is known, then the dynamic recipe mode handler 110c can by default select those settings for the cooking configuration.

Further, the cooking configuration is generated based on at least one of the complete information received from the data source and the incomplete information present from the data source. Further, the cooking configuration is generated based on a confidence score, when the incomplete information is available in the data source. The confidence score is dynamically varied based on a user feedback.

In an example, a user community can send anonymous oven usage data to a server. The server keeps count of how many times an ingredient has been used in a particular setting for the cooking configuration. More the number of times a particular setting has been used, the higher its confidence score will be.

In an embodiment, the smart microwave oven will transfer the text file of recipe to the electronic device 200 (e.g., smart phone or the like) for more detailed analysis. The available textual information undergoes contextual analysis in order to fetch relevant information and instructions for microwave oven.

Further, in order to extract the recipe parameters, the text file fed into a neural network which passes through several stages (e.g., sentence segmentation stage, Bag-of-words model, term frequency-inverse document frequency (TF-IDF) procedure, N-gram model and stemming and lemmatization stage or the like) of analysis.

The sentence segmentation stage performs a segmentation procedure on the text into words and sentences. It finds the boundaries of the text.

The bag-of-words model: In this model, the text is represented as the bag (multiset) of its words, disregarding grammar and even word order but keeping multiplicity. In this model the (frequency of) occurrence of each word is used as a feature for training a classifier. Thus, this model is mainly used as a tool of feature generation. After transforming the text into a “bag of words”, the electronic device 100 can calculate various measures to characterize the text. The most common type of characteristics, or features calculated from the Bag-of-words model is term frequency, namely, the number of times a term appears in the text. But common words like “the”, “a”, “to” are almost always the terms with highest frequency in the text. Thus, having a high raw count does not necessarily mean that the corresponding word is more important. To address this problem, one of the most popular ways to “normalize” the term frequencies is to weight a term by the inverse of document frequency.

The TF-IDF procedure is a numerical statistic that is intended to reflect how important a word is to a document in a collection or corpus. The TF-IDF value increases proportionally to the number of times a word appears in the document, but is often offset by the frequency of the word in the corpus, which helps to adjust for the fact that some words appear more frequently in general. An inverse document frequency factor is incorporated which diminishes the weight of terms that occur very frequently in the document set and increases the weight of terms that occur rarely.

The N-gram model can be used to store this spatial information within the text. The tokenization stage handles segment text into words, abbreviations and hyphenated words and provides token according to parts-of-speech.

The stemming and lemmatization procedure chops off the prefixes and suffixes of the words and analyze the family of derivatives of the word. The stemming and lemmatization stage morphologically analysis of words by using vocabulary.

In an example, the input file is parsed in the following 5 stages to make the cooking configuration.

a) First exact words corresponding to microwave settings are found (compared from database),

b) If incomplete instructions are present, the file is again scanned for presence of microwave modes,

c) If still the instructions are incomplete, the file is scanned for ingredients. When some ingredients are found, their optimal operating conditions are found. If the confidence for an operating condition is high, it is selected as the mode of operation,

d) If the first three procedures do not fetch results, the proposed method need to apply deep-text learning in the text file. The file is sent to a connected device having deep-learning capabilities. Alternatively, a deep-learning logic may be parceled with the microwave oven. Results of deep-learning are used to fill up the missing data in settings file.

e) Finally, the user input is taken on the connected device. If some data is filled up using confidence scores (step c), the confidence scores will change based on user's input.

Further, the dynamic recipe mode handler 110c is configured to dynamically generate the audio recipe and the cooking configuration for the recipe based on the recipe parameters and store the audio recipe and the cooking configuration.

In an embodiment, the dynamic recipe mode handler 110c is configured to activate the dynamic recipe mode and automatically provide the at least one cooking instruction by executing the audio recipe in the dynamic recipe mode. Further, the dynamic recipe mode handler 110c automatically configures the cooking appliance 100 by applying the cooking configuration for the recipe.

In an embodiment, the curated list of settings of microwave is presented to the user for consent. The user may modify/add/delete the process. Once given the consent by the user, the configured settings file is being made.

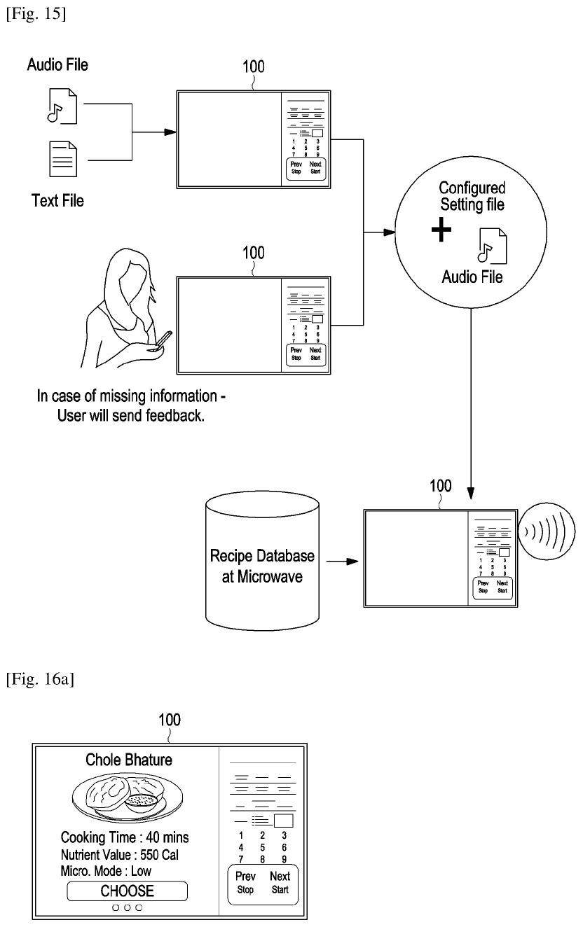

As shown in the FIG. 15, once the settings file is complete, from the next time that the recipe is made, the settings shall be automatically applied. When the recipe is selected, the settings file and audio file corresponding to that recipe is brought into the memory 130. Since the file is in a particular oven-recognizable format (e.g., JSON or XML), it is sent to the NLP 110b which parses the data and finds out the timestamps at which settings are to be applied. For each timestamp, it finds the temperature to be set, and the duration for which it is to be maintained.

The processor 140 instructs an audio module to play the audio recipe. It then starts a timer, and keeps checking if the first timestamp matches with the count of timer. When it does, it instructs the heating module to set the temperature corresponding to this timestamp. The heating module sets the intensity of the microwaves to correspond to the temperature specified in the instruction.

Although the FIG. 3 shows various hardware components of the cooking controller 110 but it is to be understood that other embodiments are not limited thereon. In other embodiments, the cooking controller 110 may include less or more number of components. Further, the labels or names of the components are used only for illustrative purpose and does not limit the scope of the invention. One or more components can be combined together to perform same or substantially similar function to generate the audio recipe and the cooking configuration in the cooking controller 110.

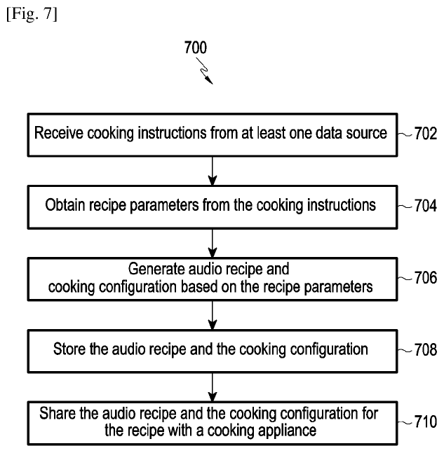

FIG. 4 is an overview of a system 1000 for providing the audio recipe and the cooking configuration, according to an embodiment as disclosed herein. In an embodiment, the system 1000 includes the cooking appliance 100 and the electronic device 200.

The electronic device 200 is configured to receive the cooking instructions from the data source and extract the recipe parameters from the cooking instructions. Further, the electronic device 200 is configured to dynamically generate the audio recipe and the cooking configuration for the recipe based on the recipe parameters and store the audio recipe and the cooking configuration. Further, the electronic device 200 is configured to share the audio recipe and the cooking configuration for the recipe with the cooking appliance 100. The cooking appliance 100 is configured to activate the dynamic recipe mode and automatically provide the at least one cooking instruction by executing the audio recipe in the dynamic recipe mode. The system 1000 automatically configures the cooking appliance 100 by applying the cooking configuration for the recipe. The operations and functions of the cooking appliance 100 and the electronic device 200 are explained in conjunction with the FIG. 1 to FIG. 3.

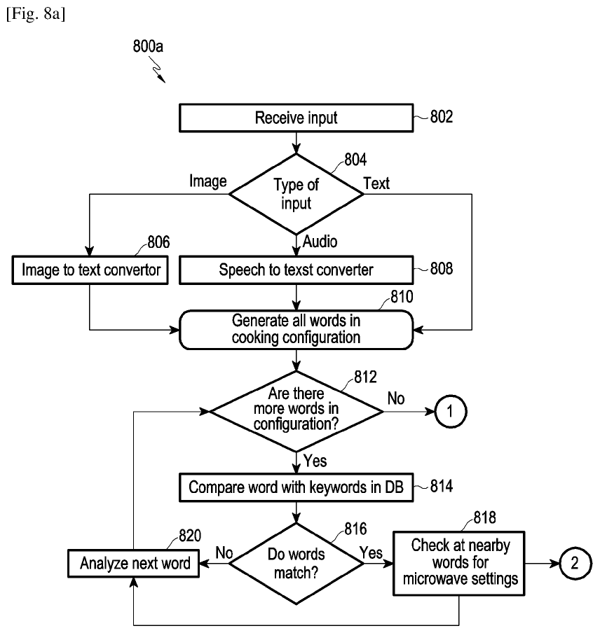

FIG. 5 is an example block diagram of the cooking appliance 100, according to an embodiment as disclosed herein. In an embodiment, the cooking appliance 100 includes the cooking controller 110, the memory 130, a microwave control unit (MCU) 500a, a voltage amplifier 500b, a magnetron 500c, a vconf persistent memory 500d, a power unit 500e, a clock system 500f, an interrupt generator 500g, a network controller 500h, and a user interface 500i. The MCU 500a is communicated and operated with the voltage amplifier 500b, the magnetron 500c, the vconf persistent memory 500d, the power unit 500e, the clock system 500f, the interrupt generator 500g, the network controller 500h, and the user interface 500i.

The functions and operations of the cooking controller 110 and the memory 130 are already explained in conjunction with the FIG. 1. Upon the configuration of the recipe, the network controller 500h generates an interrupt, indicating to the MCU 500a that the recipe is available. The MCU 500a activates the cooking controller 110 which generates a unique hash key for the recipe and adds this recipe in the database of recipes maintained in a vconf persistent memory 500d.

When the user of the cooking appliance 100 selects a recipe via the user interface (UI) 500i, it generates another interrupt for the MCU 500a to process. The user interface (UI) 500i can be, for example, but not limited to a display, a button or the like. The MCU 500a fetches the new recipe from the database and enables its clock system 500f for keeping track of when to apply the specified settings. When the settings need to be applied, the MCU 500a generates a voltage between 0V to 5V on its PWM pin corresponding to the temperature specified. This voltage is amplified by a voltage amplifier 500b and supplied to the Magnetron 500c. The magnetron 500c converts the incoming electric signal into electro-magnetic waves and cooks the food.

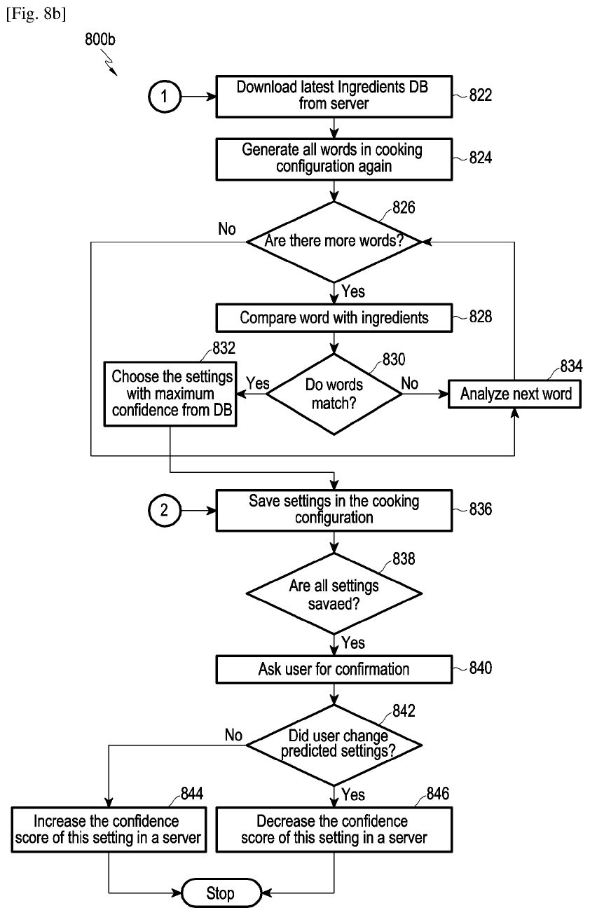

FIG. 6 is a flow diagram 600 illustrating various operations implemented, by the cooking appliance 100, for providing the audio recipe and the cooking configuration, according to an embodiment as disclosed herein. The operations (602-614) are performed by the cooking controller 110.

At 602, the method includes receiving the cooking instructions from the at least one data source. At 604, the method includes extracting the recipe parameters from the cooking instructions. At 606, the method includes dynamically generating the audio recipe and the cooking configuration for the recipe based on the recipe parameters. At 608, the method includes storing the audio recipe and the cooking configuration. At 610, the method includes activating the dynamic recipe mode. At 612, the method includes automatically providing at least one cooking instruction by executing the audio recipe in the dynamic recipe mode. At 614, the method includes automatically configuring the cooking appliance 100 by applying the cooking configuration for the recipe.

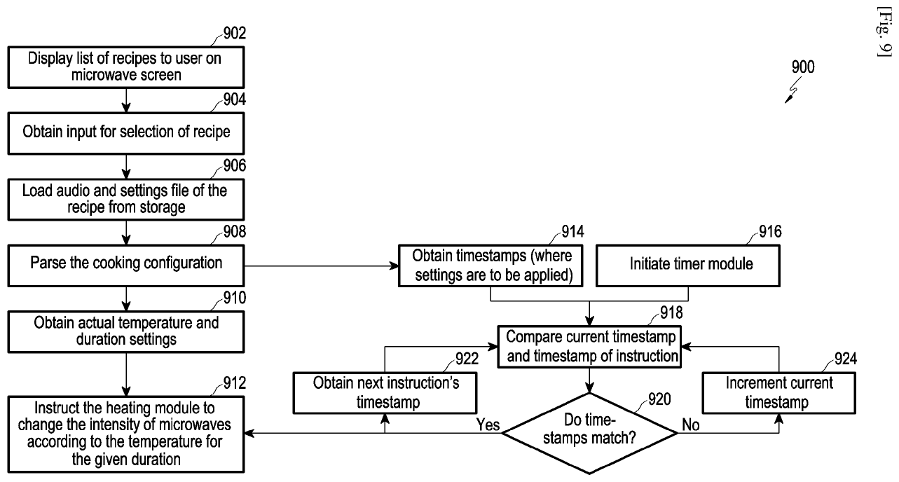

FIG. 7 is a flow diagram 700 illustrating various operations implemented, by the electronic device 200, for providing the audio recipe and the cooking configuration, according to an embodiment as disclosed herein. The operations (702-710) are performed by the cooking controller 210.

At 702, the method includes receiving the cooking instructions from the at least one data source. At 704, the method includes extracting the recipe parameters from the cooking instructions. At 706, the method includes dynamically generating the audio recipe and the cooking configuration for the recipe based on the recipe parameters. At 708, the method includes storing the audio recipe and the cooking configuration. At 710, the method includes sharing the audio recipe and the cooking configuration to the cooking appliance 100.

FIGS. 8A and 8B are flow diagrams 800a and 800b illustrating various operations implemented, by the cooking appliance 100, for providing the audio recipe and the cooking configuration, according to an embodiment as disclosed herein. The operations (802-846) are performed by the cooking controller 110.

At 802, the method includes receiving the input from the data source. At 804, the method includes determining the type of input. If the input is the image then, at 806, the method includes performing the image to text conversion for the image. If the input is the audio then, at 808, the method includes performing the speech to text conversion for the input. At 810, the method includes generating all words in the cooking configuration,

At 812, the method includes determining that there are more words in the cooking configuration. If there are more words in the cooking configuration then, at 814, the method includes comparing word with keywords in the database. At 816, the method includes determining that words match with the database. If the words match with the database then at 818, the method checking nearby words for microwave settings. If the words do not match with the database then at 820, the method includes analyzing next word.

If there are less words in the cooking configuration then, at 822, the method includes downloading latest Ingredients DB from the server. At 824, the method includes generating all words in cooking configuration again. At 826, the method includes determining there are more word. If there are more word then at 828, the method includes comparing the word with the ingredients. At 830, the method includes determining that words match with the ingredients.

If the words match with the ingredients then, at 832, the method includes choosing the settings with maximum confidence from database. If the words do not match with the ingredients then, at 834, the method includes analyzing next word. At 836, the method includes saving settings in the cooking configuration. At 838, the method includes determining that all settings are saved.

At 840, the method includes requesting the user for confirmation. At 842, the method includes determining that the user changes predicted settings. If the user does not change predicted settings then, at 844, the method includes increasing the confidence score of the setting in the server. If the user does not change predicted settings then, at 846, the method includes decreasing the confidence score of the setting in the server.

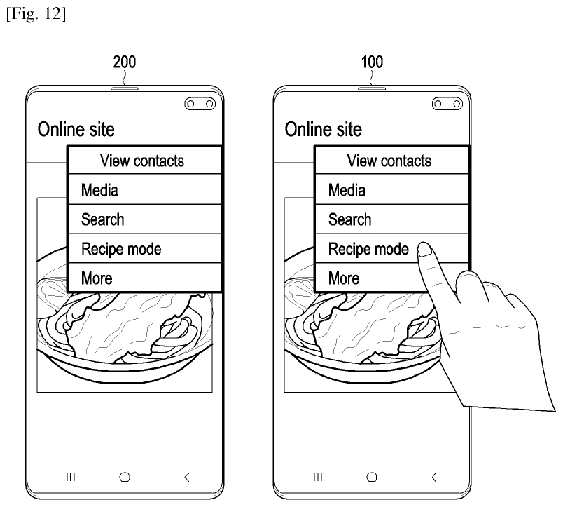

FIG. 9 is a flow diagram 900 illustrating various operations implemented, by the cooking appliance 100, for applying the audio recipe and the cooking configuration, according to an embodiment as disclosed herein. The operations (902-924) are performed by the cooking controller 110.

At 902, the method includes displaying list of recipes to the user on a screen of the cooking appliance 100. At 904, the method includes obtaining the input for selection of recipe. At 906, the method includes loading the audio recipe and the cooking configuration of the recipe from the memory 140.

At 908, the method includes parsing the cooking configuration. At 910, the method includes obtaining the actual temperature and duration settings. At 912, the method includes instructing the heating module to change the intensity of microwaves according to the temperature for the given duration. At 914, the method includes obtaining the timestamps (where settings are to be applied). At 916, the method includes initiating the timer module.

At 918, the method includes comparing current timestamp and timestamp of instruction. At 920, the method includes determining that the time-stamps do match. If time-stamps do match then at 922, the method includes obtaining next instruction's timestamp. If time-stamps do not match then at 924, the method includes incrementing current timestamp.

The various actions, acts, blocks, steps, or the like in the flow diagrams 600-900 may be performed in the order presented, in a different order or simultaneously. Further, in some embodiments, some of the actions, acts, blocks, steps, or the like may be omitted, added, modified, skipped, or the like without departing from the scope of the invention.

FIG. 15 is an example scenario in which the cooking appliance 100 applies the audio recipe and the cooking configuration, according to an embodiment as disclosed herein.

Once the settings file is complete, from the next time that the recipe is made, the cooking configuration shall be automatically applied. When the recipe is selected, the cooking configuration and the audio file corresponding to that recipe is brought into the memory 140. Since the cooking configuration is in a particular oven-recognizable format (e.g., JSON or XML), the cooking configuration is sent to the NLP 110b which parses the data and finds out the timestamps at which settings are to be applied. For each timestamp, it finds the temperature to be set, and the duration for which it is to be maintained.

The processor 140 instructs the audio module to play the audio recipe. It then starts a timer, and keeps checking if the first timestamp matches with the count of timer. When it does, it instructs the heating module to set the temperature corresponding to this timestamp. The heating module sets the intensity of the microwaves to correspond to the temperature specified in the instruction. The processor 140 finds the expiry time of this instruction—it will be the sum of current timestamp and duration. When the timer matches the expiry time, the processor 140 retracts the last instruction.

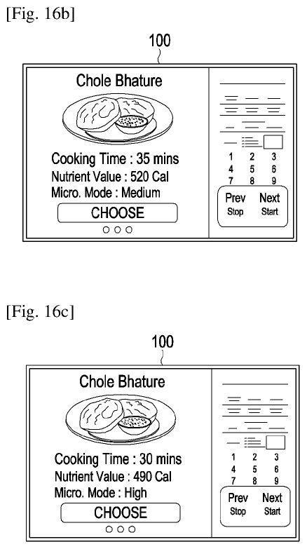

FIGS. 16A to 16C are example scenarios in which the application of cooking configuration in the cooking appliance 100 is depicted, according to an embodiment as disclosed herein.

Once the settings file is generated, it is saved into the memory 130 of the smart oven. The smart oven also makes variants of the recipe which have improve preparation time/nutritional value. The next time when the recipe is run, the settings file is applied automatically.

The user can select the recipe from the oven's UI. Once the user selects the recipe, its variants are presented on the connected device. The user can select the variant that he wants. The audio and settings file corresponding to the recipe will be brought into the memory 130 of oven. The audio file will start playing in stepwise manner.

The embodiments disclosed herein can be implemented using at least one software program running on at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for providing an audio recipe and a cooking configuration for a cooking appliance, comprising:
receiving cooking instructions from at least one data source;
obtaining at least one recipe parameter from the cooking instructions;
generating the audio recipe and the cooking configuration corresponding to the audio recipe based on the at least one recipe parameter; and
storing the audio recipe and the cooking configuration.

2. The method of claim 1, further comprising:
activating a dynamic recipe mode;
providing at least one cooking instruction by executing the audio recipe in the dynamic recipe mode; and
setting a cooking appliance by applying the cooking configuration corresponding to the audio recipe.

3. The method of claim 2, wherein the providing of the at least one cooking instruction comprises providing an ingredient preparation instruction and providing an instruction on loading a set of ingredients in the cooking appliance.

4. The method of claim 1, wherein the at least one data source comprises a call, a microphone at a cooking appliance, a chat history, an image document, a video content, and a virtual assistant application.

5. The method of claim 1, wherein the at least one data source is operating in a recipe mode.

6. The method of claim 1, wherein obtaining the at least one recipe parameter comprises:
identifying at least one keyword from the cooking instructions;
determining whether the at least one keyword match with at least one of time, temperature, a mode of a cooking appliance and an ingredient in a cooking database; and
extracting the at least one recipe parameter from the cooking instructions based on the at least one identified keyword when the match is detected.

7. The method of claim 6, wherein the determining of whether the at least one keyword match comprises:
downloading an ingredients database;
matching the at least one keyword with information available in the ingredients database.

8. A cooking appliance comprising:
a memory;
a processor; and
a cooking controller, coupled to the memory and the processor, configured to:
receive cooking instructions from at least one data source,
obtain at least one recipe parameter from the cooking instructions,
generate an audio recipe and a cooking configuration corresponding to the audio recipe based on the at least one recipe parameter, and
store the audio recipe and the cooking configuration.

9. The cooking appliance of claim 8, wherein the cooking controller is further configured to:
activate a dynamic recipe modes;
provide at least one cooking instruction by executing the audio recipe in the dynamic recipe mode; and
set the cooking appliance by applying the cooking configuration corresponding to the audio recipe.

10. The cooking appliance of claim 9, wherein cooking controller is further configured to provide an ingredient preparation instruction and providing an instruction on loading a set of ingredients in the cooking appliance.

11. The cooking appliance of claim 8, wherein the at least one data source comprises a call, a microphone at the cooking appliance, a chat history, an image document, a video content, and a virtual assistant application.

12. The cooking appliance of claim 8, wherein the at least one data source is operating in a recipe mode.

13. The cooking appliance of claim 8, wherein the cooking controller is further configured to:
identify at least one keyword from the cooking instructions,
determine whether the at least one keyword match with at least one of time, temperature, a mode of the cooking appliance and an ingredient in a cooking database, and
extract the at least one recipe parameter from the cooking instructions based on the at least one identified keyword when the match is detected.

14. The cooking appliance of claim 13, wherein the cooking controller is further configured to:
download an ingredients database,
match the at least one keyword with information available in the ingredients database.

15. (canceled)

16. The cooking appliance of claim 8, wherein the cooking controller is further configured to:
share the audio recipe and the cooking configuration with a cooking appliance.

17. The method of claim 1, further comprising:
sharing the audio recipe and the cooking configuration with a cooking appliance.
